(19) United States
(12) Patent Application Publication
(10) Pub. No.: US 2007/0016638 A1
(43) Pub. Date: Jan. 18, 2007

(54) System and method of application provisioning

(76) Inventors: Ian Elbury, New Westminster (CA); Rastislav Hodul, Port Moody (CA)

Correspondence Address: PERMAN & GREEN, 425 POST ROAD, FAIRFIELD, CT, 06824, US

(21) Appl. No.: 11/172,456

(22) Filed: Jun. 30, 2005

(51) Int. Cl. G06F 15/16

(52) U.S. Cl. 709/201

(57) ABSTRACT

An application provisioning system and method for administering and delivering software applications to client devices are provided. The application provisioning system comprises a repository for storing a component package and maintaining a mobile device application profile, a component manager web service module for sending the component package to a mobile device, and a component manager client module for receiving and processing the component package. The method comprises the steps of receiving a request for a client device application profile, obtaining a first component package that includes the client application profile, sending the first component package to the client device, and processing the first component package.

### FIELD OF INVENTION

The present invention relates generally to distributed mobile applications, and in particular, to a system and method of application provisioning.

### BACKGROUND OF THE INVENTION

Enterprises may have many mobile devices. Each mobile device comprises application software that is updated from time to time. If a new version of an application is created, the application may be updated on each mobile device of the enterprise by physically transporting each mobile device to a central location to be updated. Alternatively, a memory card may be sent to users of mobile devices containing the application upgrade to be installed on the mobile devices. Alternatively, the device may be managed from a personal computer software updates.

There are a number of application provisioning systems by multiple vendors. Each system requires a user to update the applications. This is onerous for the enterprise to manage.

### SUMMARY OF THE INVENTION

The present invention relates to distributed mobile applications where data collection can take place in environments with and without radio (or other telecommunication) coverage. It is an object of the invention to provide a system and method of application provisioning.

In accordance with an embodiment of the invention, there is provided an application provisioning system and for administering and delivering software applications to client devices. The application provisioning system comprises a repository for storing a component package and maintaining a mobile device application profile, a component manager web service module for sending the component package to a mobile device, and a component manager client module for receiving and processing the component package.

In accordance with another embodiment of the invention, there is provided a method of administering and delivering software applications to client devices. The method comprises the steps of receiving a request for a client device application profile, obtaining a first component package that includes the client application profile, sending the first component package to the client device, and processing the first component package.

Advantageously, the application provisioning system provides a centrally managed application assignment that is transparent to the user. A client component downloads what applications are required automatically. Preferably, web services is used for client to server communication (open standard).

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows in a network connectivity diagram an example of a system overview of a design, development and operational environment, in accordance with an embodiment of the invention;

FIG. 2 shows in a software module diagram another example of a system overview of a design, development and operational environment, in accordance with an embodiment of the invention;

FIG. 3 shows an example an application provisioning system for administering and delivering software applications to client devices, in accordance with an embodiment of the invention;

FIG. 4 shows in a flowchart a method of application provisioning, in accordance with an embodiment of the application provisioning system;

FIG. 5 shows in a tree diagram an example of an organizational grouping, in accordance with an embodiment of the application provisioning system;

FIG. 6 shows another example of an application provisioning system for administering and delivering software applications to client devices;

FIG. 7 shows in a flowchart another example of a method of application provisioning, in accordance with an embodiment of the application provisioning system; and

FIG. 8 shows in a flowchart an example of a method of processing a component package, in accordance with an embodiment of the application provisioning system.

### DETAILED DESCRIPTION

The following description is of a preferred embodiment.

The present invention will be further illustrated in the following examples.

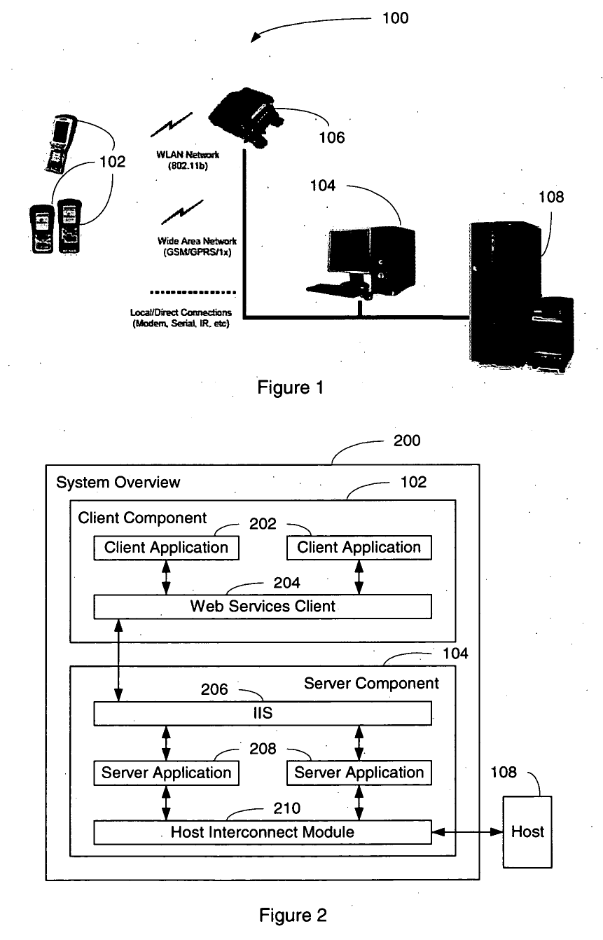

FIG. 1 shows in a network diagram an example of a system overview 100 of a design, development and operational environment for deploying feature rich applications (that may or may not use web services for communication with a server) to mobile devices and desktop personal computers, in accordance with an embodiment of the invention. The system overview 100 comprises one or more or mobile client components (or handheld terminals) 102 for allowing a user to collect, review and modify data; a server component 104 for providing applications and connectivity options to external systems; a network 106 for allowing the handheld terminals 102 to communicate with the server component 104 via a communications protocol; and a back-end system (or host) 108 for providing a database or enterprise resource planning (ERP) system. Examples of mobile components may include personal computers (PCs), vehicle mount computers, tablet PCs, and devices with embedded operating systems, etc.

FIG. 2 shows in a layer diagram another example of a system overview 200 of a design, development and operational environment, in accordance with an embodiment of the invention. The mobile client component 102 comprises one or more client applications 202 that communicate with a web services client 204. The server component 104 comprises an Internet information server (IIS) 206 for communicating with the web services client 204, one or more server applications 208 and a host interconnect module 210 for communicating with the host (or back-end system) 108. The server applications 208 communicate with both the IIS 206 and the host interconnect module 210.

An application console may be installed as client application 202 on the mobile client component 102 to provide a presentation layer and application framework that end users use to collect, review and modify data. The application console communicates with the server component 104 via web services running on the IIS 206. The server component 104 is a middle tier where data is synchronized before being sent to the back-end system 108.

The server component 104 provides the applications and connectivity options to integrate back-end systems 108. A unified administration console for administering middleware on may be installed as a server application 206 to provide a single source for system management and monitoring and can be used remotely. Advantageously, the unified administrative console simplifies multi-site, multi-device management and deployment. This allows for ease of deployment and controlled rollouts. Host interconnect modules 210 provide the information and logic used to integrate with the back-end systems 108.

Back-end systems 108, whether databases or full-featured enterprise resource planning (ERP) systems, are supported via the host interconnect modules 210 installed on the server component 104. Standard interface technologies are supported, including extensible markup language (XML) and open database connectivity (ODBC), as well as ERP-specific interfaces.

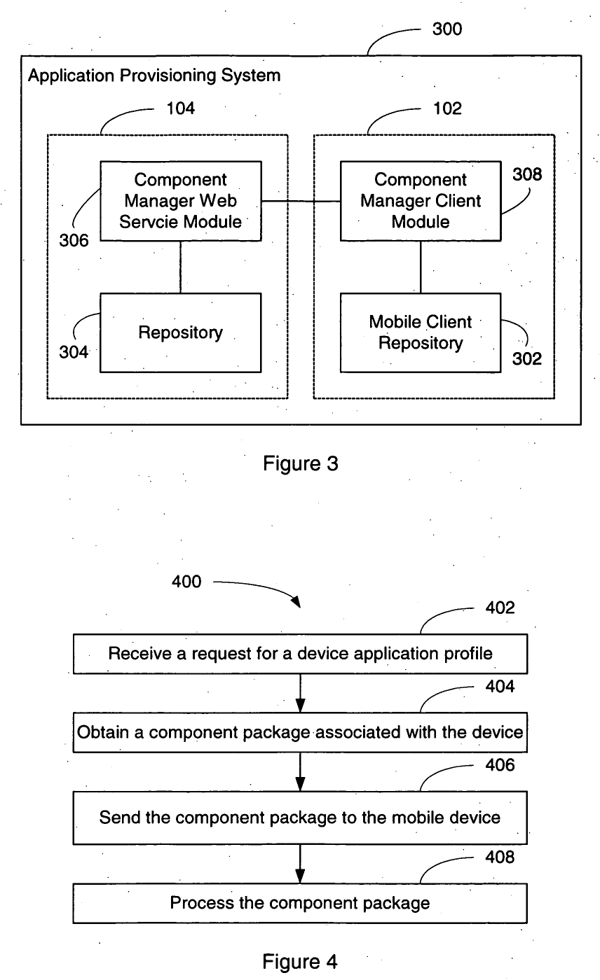

FIG. 3 shows an example an application provisioning system 300 for administering and delivering software applications to client devices 102, in accordance with an embodiment of the invention. The application provisioning system 300 comprises a repository (or database) 304 for storing component packages and maintaining mobile device application profiles, a component manager web service module 306 for sending component packages to a mobile device, a component manager client module 308 for receiving component packages and processing component packages, and a client repository 302 for storing a client profile. The component manager web service module 306 communicates with the repository 304 and with the component manager client module 308. The client repository 302 communicates with the component manager client module 308. The client repository 302 and the component manager client module 308 are implemented as code in a mobile device 102, while the repository 304 and component manager web service module 306 are implemented as code in the server component 104. Other components may be added to the application provisioning system 300, including a component manager administration module for creating a component package to be sent to a mobile device 102, and a reporting module for advising an administrative user of the system regarding the state of the mobile workers and if any had problems synchronizing.

Preferably, the mobile device 102 topology is centrally administered on the server 104. During administration, the workstation 102 (device or personal computer) is assigned to a site, which is a logical geographical unit (e.g., a warehouse). A site can have many workstations. When the application for the workstation is developed it is inserted into the repository 304 of components. Then the particular version of the application is assigned to the workstation. There is also another logical unit called Group. Group unlike the site is more logical then geographical, e.g., picking. Workstations can be assigned from multiple sites to a group if those workstations are used for the same type of work. Then the application can be assigned to the group and it will get distributed to all workstations in that group (across multiple sites). Advantageously, the same application does not need to be assigned to every single workstation. Groups are further described below.

FIG. 4 shows in a flowchart a method of application provisioning (400), in accordance with an embodiment of the application provisioning system 300. Preferably, when an application console is run for the first time on a device 102, it prompts the user for Site ID and Workstation ID. This information is communicated to the server whenever required during communication. When a device 102 is activated, the component manager client module 308 sends a request for the device application profile to the component management web service module 306. The component management web service module 306 receives the request for the device application profile (402) and obtains a component package that includes an application profile (404) associated with the device 102 that is stored in the repository 304. The component manager web service module 306 sends the component package to the mobile device 102 (406) where it is processed (408). Other steps may be added to the method (400), including the steps of generating a component package to be sent to a mobile device 102, storing component packages in a repository along with mobile device profiles and user profiles, and receiving the component package.

A group is a logical grouping of workstations (e.g., by task). A version of a component can be assigned to the workstation directly or to the group. A component can have multiple versions. Preferably, each component has a collection of install and uninstall commands.

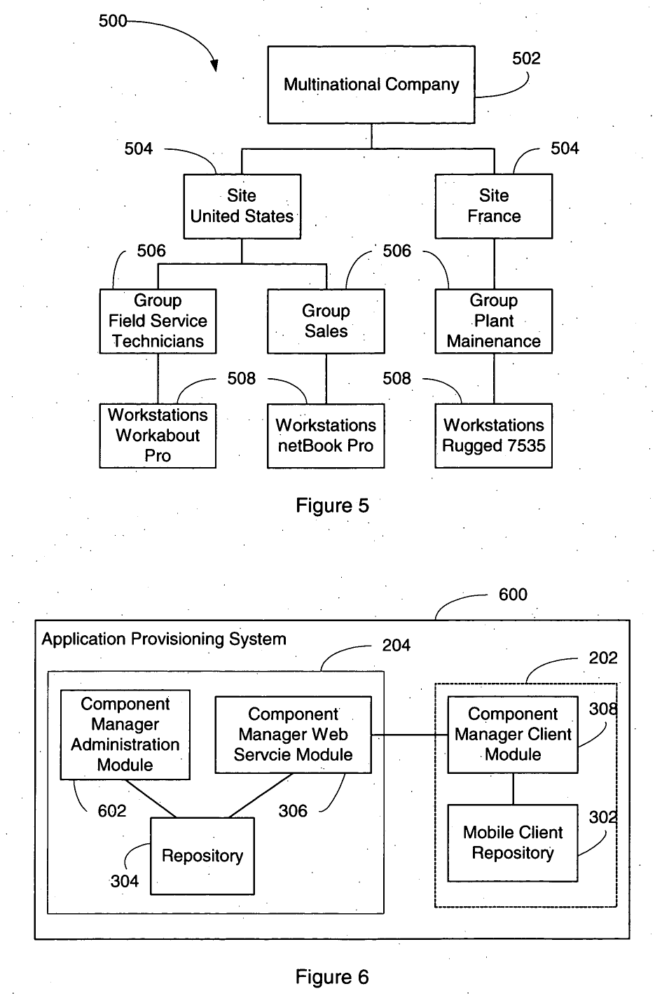

FIG. 5 shows in a tree diagram an example of an organizational grouping 500, in accordance with an embodiment of the application provisioning system 300. The organizational grouping comprises a root company tier 502, a location tier 504 for defining physical or logical locations, a group tier 506 for defining user functionality, and a workstation tier 508 for defining a specific site of the organization. Business applications are grouped together and then the groups are assigned to workstations 102 (these groups can spawn across multiple sites). The workstations 102, running a single instance of the application provisioning system 300 in an application console, are defined for each site 506. This offers the flexibility of targeting functionality to groups of workstations that are designed specifically for that purpose. Typically, different devices are used for customer relationship management than the devices used at a receiving dock.

Preferably, users are also created on a per-site basis to ensure users work in the areas to which they are assigned. As the number and type of tasks each workstation user does can vary, it may be desirable to limit which users can perform the tasks. Users may be assigned roles, tokens and dynamic properties, which the application (device-based) or web method (server-based) validates to decide how the user or process may proceed. Provisioning is open to all users. An application (e.g., Picking) can take advantage of roles, tokens, users and dynamic properties.

FIG. 6 shows another example of an application provisioning system 600 for administering and delivering software applications to client devices 102. The application provisioning system 600 comprises a component manager administration module 602 for creating a component package to be sent to a mobile device 102, the repository 304, the component manager web service module 306, the component manager client module 308, and a client repository 608 for storing a client profile associated with the device 102. The component manager administration module 602 communicates with the repository 304 and is implemented as code in the server component 104. The client repository 608 is implemented as code in the device 102 and communicates with the component manager client module 308. The component package may include instructions regarding how to process the application profile. Other components may be added to the system 600, including a reporting module for advising an administrative user of the system regarding the state of the mobile workers and if any devices or users had problems synchronizing, and a notification module to notify a mobile client user that a device is up-to-date.

The client 202 contacts the server 204 upon start-up and synchronizes the assigned application. Upon start-up of the client 202, the component manager client module 308 is invoked and communicates with the component manager web service module 306 to determine what components are assigned to the workstation 102 upon which the client 202 is located. The service 306 returns the list of components that are assigned to the workstation 102 directly and indirectly through the group. The client 202 then checks a local repository 302 to see what components it already has installed to determine what new components to download and install. If there is a component installed on the client and that component (by version) does not appear in the list of components supplied by the service 306, such component will be uninstalled (using uninstall commands).

Preferably, the component manager client 308 synchronizes the workstation components before logging-on to the client. That way the server can send the user database to the client. For example, if a user who worked in a first warehouse was let go by an organization, any interaction the user has with a mobile device is undesirable for the organization. Advantageously, the application provisioning system 300, 600 prevents any damage to the organization by having the device download a new user database (before login) and then asking the user to login. Provided that the component manager administration module 602 had been notified about the change in the user's relationship with the employer, the user is no longer able to login.

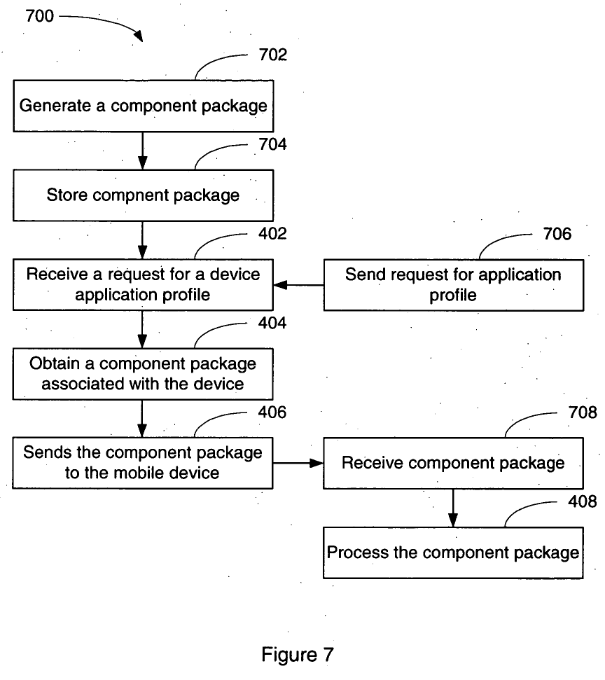

FIG. 7 shows in a flowchart another example of a method of application provisioning (700), in accordance with an embodiment of the application provisioning system 600. The method comprises the step of generating a component package (702) to be sent to a mobile device 102. The generated component package is stored (704) in a repository along with mobile device profiles and user profiles. When a device 102 is activated, the component manager client module 308 sends a request for the device application profile (706) to the component management web service module 306. The component management web service module 306 receives the request for the device application profile (402) and obtains a component package that includes an application profile (404) associated with the device 102 that is stored in the repository 304. The component package may also include instructions regarding how to process the application profile. The component manager web service module 306 sends the component package to the mobile device 102 (406). The component package is received by the component manager client module 308 (708) where it is processed (408).

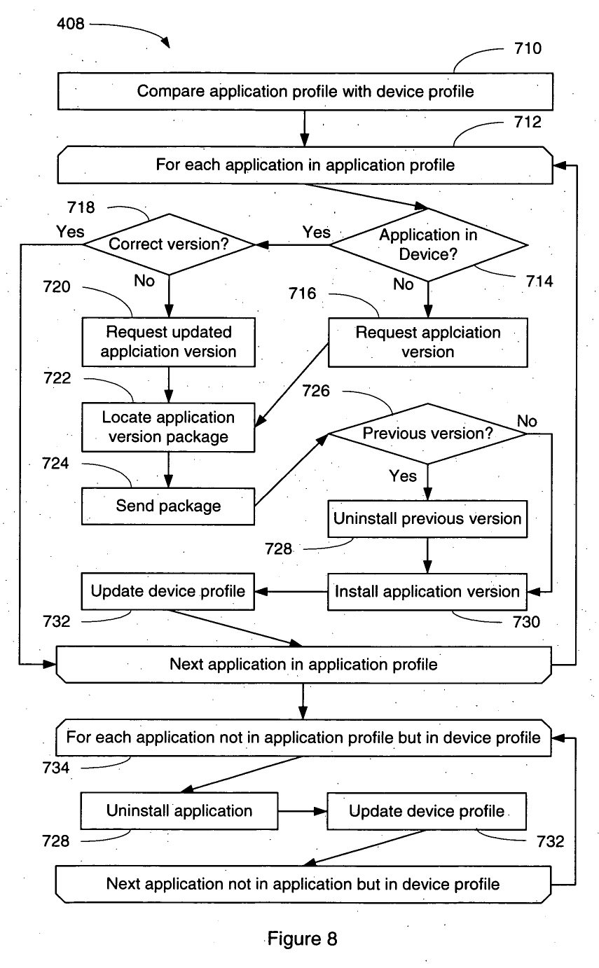

FIG. 8 shows in a flowchart an example of a method of processing a component package (408), in accordance with an embodiment of the application provisioning system 600. The method (408) includes the step of comparing an application profile included in the component package with a device profile (710) stored in the device repository 508. The component manager client module 308 looks at the next application listed in the device profile (712). If the application is not in the device profile (714), then the component manager client module 308 sends a request for a version of the application (716) to the component manager web service 306. If the application is in the device profile (714), but the application version does not match (718), then the component manager client module 308 sends a request for a version of the application (720) to the component manager web service 306. The component manager web service 306 locates the application (722) in the repository 304, preferably compresses it for better network performance, and sends it to the component manager client module 308 in a component package (724).

If there is a previous version of the application installed (726), then the component manager client module 308 uninstalls the previous version of the application (728) in the mobile client 202. The received version is installed (730) in the mobile client 202 and the device profile entry for this application is updated to match the corresponding application profile entry (732). Preferably, instructions have been sent earlier with the application profile, such that only the version of the application (preferably its binary is downloaded per request). Alternatively, instructions may be sent along with an application binary. Once the device profile is updated (732) and there are more applications listed in application profile (734), then steps (712) to (732) are repeated until all the applications listed in the application profile are updated in the device.

For each application present in the device profile that is not present in the application profile (734), the component manager client module 308 uninstalls the application (728) from the mobile client 202 and updates the device profile entry for that application to match the corresponding application profile entry (732). Alternatively, an application may be disabled rather than uninstalled. Steps (734) to (732) are repeated until there are no more applications to uninstall from the client. Other steps may be added to the method (700) and/or processing step (408), including reporting the state of the mobile workers and if any devices or users had problems synchronizing, and sending a notification to a mobile client user that a device is up-to-date.

Advantageously, as an administrator operating on the server 104 determines the distribution of the components on the server 104, the client component 102 is only required to download any new components and install them as needed. Advantageously, the application provisioning system 300, 600 provides a centrally managed application assignment that is transparent to the user. A client component 102 downloads what applications are required automatically. Thus, a user is not prompted to download and install/uninstall the applications. The applications assigned to the workstation (or mobile client) 102 are decided by the central administrator. Preferably, web services is used for client to server communication (open standard).

The application provisioning system and method according to the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. An application provisioning system for administering and delivering software applications to client devices, the application provisioning system comprising:
a repository for storing a component package and maintaining a mobile device application profile;
a component manager web service module for sending the component package to a mobile device; and
a component manager client module for receiving and processing the component package.

2. The application provisioning system as claimed in claim 1, the component package includes instructions regarding how to process the application profile.

3. The application provisioning system as claimed in claim 1, further comprising a client repository for storing a client profile.

4. The application provisioning system as claimed in claim 1, further comprising a component manager administration module for creating the component package.

5. The application provisioning system as claimed in claim 1, wherein a plurality of applications are grouped together and assigned to workstations.

6. The application provisioning system as claimed in claim 5, wherein the workstations are further grouped into logical sections of an organization.

7. The application provisioning system as claimed in claim 6, wherein the logical sections of the organization are furtther grouped into logical geographical locations of the organization.

8. The application provisioning system as claimed in claim 1, further comprising a reporting module for reporting the state of the mobile device.

9. The application provisioning system as claimed in claim 1, further comprising a notification module to notify a mobile device client that the mobile device is up-to-date.

10. A method of administering and delivering software applications to client devices, the method comprising the step of:
receiving a request for a client device application profile;
obtaining a first component package that includes the client application profile;
sending the first component package to the client device; and
processing the first component package.

11. The method as claimed in claim 10, further comprising the step of generating the first component package.

12. The method as claimed in claim 10, further comprising the step of storing the first component package in a repository.

13. The method as claimed in claim 10, wherein a client module sends the request for the client device application profile.

14. The method as claimed in claim 10, wherein a server module sends the first component package to the client device.

15. The method as claimed in claim 10, further comprising the step of including instructions regarding how to process the application profile in the first component package.

16. The method as claimed in claim 10, wherein the step of processing includes the steps of:
comparing the application profile with a device profile stored in the client device;
sending a request for an application version to a server module;
receiving a second component package including the application version from the server module;
installing the application version on the client device.

17. The method as claimed in claim 16, further comprising the steps comparing a received application version entry in the application profile with a stored application version entry in the device profile.

18. The method as claimed in claim 17, further comprising the step of sending a request for the received application version entry version of the application.

19. The method as claimed in claim 16, further comprising the steps of:
receiving a request for an application version;
locating the application version in a server repository; and
sending the application version to the client device.

20. The method as claimed in claim 19, further comprising the step of compressing the application version into a binary file in the second component package.

21. The method as claimed in claim 16, wherein the step of installing includes the steps of:
locating an entry of a previous version of the application in the device profile; and
uninstalling the previous version of the application from the device.

22. The method as claimed in claim 16, further comprising the step of updating an entry of the application in the device profile to match the corresponding application profile entry.

23. The method as claimed in claim 16, wherein instructions to install the application version are provided in the second component package.

24. The method as claimed in claim 16, further comprising the steps of:
locating an entry of an application in the device profile that is not on the application profile;
uninstalling the application; and
updating the entry of the application in the device profile to match the corresponding application profile entry.

25. The method as claimed in claim 16, further comprising the step of reporting the state of the mobile device.

26. The method as claimed in claim 16, further comprising the step of sending a notification to a mobile client device that it is up-to-date.

27. The method as claimed in claim 10, further comprising the steps of:
grouping a plurality of applications; and
assigning the groupings to workstations.

28. The method as claimed in claim 10, further comprising the step of grouping the workstations into logical sections of an organization.

29. The method as claimed in claim 10, further comprising the step of grouping the logical sections of the organization into logical geographical locations of the organization.
